(19) United States
(12) Patent Application Publication
(10) Pub. No.: US 2009/0109210 A1
(43) Pub. Date: Apr. 30, 2009

(54) DRIVING DEVICE, DRIVING METHOD, ELECTRO-OPTICAL DEVICE, AND ELECTRONIC APPARATUS

(75) Inventor: Akihiko ITO, Tatsuno-machi (JP)

Correspondence Address: Workman Nydegger;1000 Eagle Gate Tower, 60 East South Temple, Salt Lake City, UT, 84111, US

(73) Assignee: SEIKO EPSON CORPORATION, Shinjuku-ku (JP)

(21) Appl. No.: 12/256,738

(22) Filed: Oct. 23, 2008

(30) Foreign Application Priority Data
Oct. 25, 2007 (JP) 2007-277683

(51) Int. Cl. G09G 5/00

(52) U.S. Cl. 345/214

(57) ABSTRACT

A device drives an electro-optical device with a pixel area of arrayed pixels. A calculating section that calculates a difference between a gradation of an original image signal for one of the pixels and a gradation of the original image signal for an adjacent pixel that is adjacent to the one of the pixels. A correction-amount determining section determines, on the basis of the difference, a correction amount used for correcting a part of the original image signal that corresponds to the one of the pixels. The correction-amount determining section determines the correction amount to reduce a potential difference between the part of the original image signal and another part of the original image signal that corresponds to the adjacent pixel. A correcting section corrects the one part of the signal on the basis of the correction amount.

### BACKGROUND

1. Technical Field

The present invention relates to a device and a method for driving an electro-optical device such as a liquid crystal device or the like. In addition, the invention relates to an electro-optical device that is provided with such a driving device and an electro-optical device that is operated by such a driving method. Moreover, the invention further relates to an electronic apparatus that is provided with such an electro-optical device. A non-limiting example of an electronic apparatus to which the invention is directed is a liquid crystal projector.

2. Related Art

In the technical field to which the present invention pertains, a device for driving an electro-optical device such as a liquid crystal device or the like that is capable of preventing the occurrence of a “disclination-line” display failure is known, though not perfectly as explained below. Such a driving device of the related art prevents the generation of disclination lines, which is display unevenness that arises at the time when an electro-optical device displays an image, thereby improving the image display quality thereof to some extent. The disclination-line display unevenness occurs at a region between adjacent pixels or in a pixel area. The disclination line(s) appears as local (i.e., regional, partial, or the like) darkness due to a decrease in brightness (i.e., luminance). Or, the disclination line might be observed as a bright area due to optical leakage. The disclination-line display problem arises because of the disorder of electric fields applied to liquid crystal. For example, it is likely that the disclination-line display unevenness is visually recognized if any unexpected horizontal electric field is generated when it is supposed that a vertical electric field is applied in a direction perpendicular to the surface of a substrate. In an effort to provide a technical solution to the problem of the disclination-line display unevenness explained above, a technique for preventing the generation of a disclination line is described in, for example, JP-A-11-295697. In the related-art technique of JP-A-11-295697, when a driver operates a liquid crystal display device while reversing drive polarities, the length of a time period during which the polarity of a voltage that is applied to a certain pixel is opposite to the polarity of a voltage that is applied to another pixel that is adjacent to the above-mentioned certain pixel is minimized. Because of such a shortened reverse-polarity voltage period, the related-art technique of JP-A-11-295697 makes it possible to effectively reduce the disclination-line display unevenness explained above.

However, in the related-art technique of JP-A-11-295697, the above-explained time period during which the polarity of a voltage that is applied to a certain pixel is opposite to the polarity of a voltage that is applied to another pixel that is adjacent to the above-mentioned certain pixel still exists although the length thereof is significantly shortened. For this reason, if the related-art technique of JP-A-11-295697 explained above is adopted, the problem of the disclination-line display unevenness arises during the reverse-polarity voltage period though the length thereof is significantly shortened. In addition, a disclination line could be generated even in a non-reverse-polarity voltage period during which the polarity of a voltage that is applied to a certain pixel is not opposite to the polarity of a voltage that is applied to another pixel that is adjacent to the above-mentioned certain pixel. The reason why there is an adverse possibility of the generation of a disclination line even in the non-reverse-polarity voltage period is that an electric-potential difference occurs between one pixel and another pixel adjacent thereto due to a difference in display gradations therebetween. That is, the related-art technique of JP-A-11-295697 explained above has a technical disadvantage in that it is practically impossible or at best difficult to suppress the disorientation (i.e., disorder in the orientation) of liquid crystal due to the disorder of electric fields applied to liquid crystal or due to the generation of any unexpected horizontal electric field.

### SUMMARY

An advantage of some aspects of the invention is to provide a driving device and a driving method that is capable of preventing the generation of any disclination line in the display area of an electro-optical device, thereby making it further possible to enhance the image quality thereof. In addition, the invention provides, as an advantage of some aspects thereof, an electro-optical device that is provided with such a driving device and an electro-optical device that is operated by such a driving method. Moreover, the invention further provides, as an advantage of some aspects thereof, an electronic apparatus that is provided with such an electro-optical device.

In order to address the above-identified problem without any limitation thereto, the invention provides, as a first aspect thereof, a device for driving an electro-optical device, the driving device correcting an original image signal that indicates, on a pixel-by-pixel basis, an image that is to be displayed in a pixel area, which is made up of a plurality of arrayed pixels, the driving device supplying a corrected image signal to the electro-optical device that has the pixel area so as to drive the electro-optical device, the driving device including: a calculating section that calculates, on an adjacent-pixel-by-adjacent-pixel basis, a difference in a gradation of the original image signal in one of the plurality of arrayed pixels and a gradation of the original image signal in another one or more pixels that are adjacent to the first-mentioned one pixel; a correction-amount determining section that determines, on an adjacent-pixel-by-adjacent-pixel basis, and on the basis of the calculated difference, a correction amount that is used for correcting one signal portion that is a part of the original image signal, the above-mentioned one signal portion corresponding to the first-mentioned one pixel, the correction-amount determining section determining, on an adjacent-pixel-by-adjacent-pixel basis, and on the basis of the calculated difference, a correction amount that is used for correcting the above-mentioned one signal portion in such a manner that a potential difference between the above-mentioned one signal portion and another one or more signal portions corresponding to the above-mentioned one or more pixels that are adjacent to the first-mentioned one pixel is reduced; a combining section that combines, into one combined correction amount, correction amounts each of which is determined for the corresponding adjacent pixel so as to be used for correction at the first-mentioned one pixel; a correcting section that corrects the first-mentioned one signal portion on the basis of the combined correction amount; and a signal supplying section that supplies the corrected image signal, which is obtained as a result of the correction of the first-mentioned one signal portion that is a part of the original image signal, to the electro-optical device in a predetermined format.

As a first step of the operation flow of a driving device according to the first aspect of the invention described above, an original image signal is inputted into the device. The original image signal indicates, on a pixel-by-pixel basis, an image that is to be displayed in a pixel area, which is made up of a plurality of arrayed pixels. Upon the reception of the original image signal, a calculating section calculates, on an adjacent-pixel-by-adjacent-pixel basis, a difference in a gradation of the original image signal in one of the plurality of arrayed pixels and a gradation of the original image signal in another one or more pixels that are adjacent to the first-mentioned one pixel. The calculating section is provided with, for example, a processor, a memory, and the like. As a typical non-limiting configuration example thereof, the calculating section calculates a difference in a gradation of the original image signal in one of the plurality of arrayed pixels and a gradation of the original image signal in another one or more pixels that are adjacent to the first-mentioned one pixel for each of the above-mentioned another one or more pixels that are adjacent to the first-mentioned one pixel. For example, it is assumed here for the purpose of explanation that four adjacent pixels surround one center pixel so as to form a cross. One of these four adjacent pixels (left pixel) is located to the left of the above-mentioned one center pixel, whereas another one of these four adjacent pixels (right pixel) is located to the right of the above-mentioned one center pixel. Still another one of these four adjacent pixels (top pixel) is located on the preceding row at the corresponding position when viewed from the above-mentioned one center pixel, or simply said, located over the above-mentioned one center pixel, whereas the remaining one of these four adjacent pixels (bottom pixel) is located on the next row at the corresponding position when viewed from the above-mentioned one center pixel, or simply said, located under the above-mentioned one center pixel. In such a cross array, as a typical non-limiting configuration example of a driving device according to the first aspect of the invention described above, four differences are calculated for one target pixel (i.e., center pixel). Notwithstanding the above, however, it is not always necessary for the calculating section to calculate a difference in a gradation of the original image signal in one of the plurality of arrayed pixels and a gradation of the original image signal in another one or more pixels that are adjacent to the first-mentioned one pixel for each of these adjacent pixels. That is, advantageous effects of this aspect of the invention including those not explicitly described herein can be obtained even when the calculation of a difference is not performed for some of adjacent pixels. In other words, under the same assumption as above where four adjacent pixels surround one center pixel so as to form a cross, the number of differences calculated by the calculating section may be any of one, two, and three in place of four. The scope of this aspect of the invention encompasses such a variety of configurations.

As a next step of the operation flow of a driving device according to the first aspect of the invention described above, a correction-amount determining section determines a correction amount on an adjacent-pixel-by-adjacent-pixel basis and on the basis of the calculated difference. The correction-amount determining section is provided with a processor, a memory, and a comparator, without any limitation thereto. The correction amount that is determined by the correction-amount determining section is used for correcting one signal portion that is a part of the original image signal. The above-mentioned one signal portion corresponds to the first-mentioned one pixel. The correction-amount determining section determines, on an adjacent-pixel-by-adjacent-pixel basis, and on the basis of the calculated difference, the correction amount that is used for correcting the above-mentioned one signal portion in such a manner that a potential difference between the above-mentioned one signal portion and another one or more signal portions corresponding to the above-mentioned one or more pixels that are adjacent to the first-mentioned one pixel is reduced. The term “signal portion” used herein means an individual pixel signal that is a part of the original image signal. In other words, the signal portion means an original pixel signal. That is, it can be said that an image signal is an aggregate of a plurality of signal portions that corresponds to a plurality of pixels, or, in other words, an aggregate of a plurality of pixel signals. As a typical non-limiting configuration example thereof, the number of (sets of) correction amounts determined by the correction-amount determining section equals to the number of calculated differences. For example, if the number of differences calculated by the calculating section is four as in the foregoing example, the correction-amount determining section determines four correction amounts. The correction amount may be determined by means of, for example, a mathematical formula. Or, the correction amount may be determined on the basis of, for example, a reference table that is prepared in advance.

Upon the determination of the correction amount on an adjacent-pixel-by-adjacent-pixel basis, the combining section combines, into one combined correction amount, these correction amounts each of which is determined for the corresponding adjacent pixel so as to be used for correction at the first-mentioned one pixel. The combining section is provided with, for example, a processor, a memory, and the like. That is, through this combination process, a plurality of correction amounts that is to be used for correction at the first-mentioned one pixel is combined into one correction amount. For example, the combination of these correction amounts may be performed as a result of the addition of them to each other or one another. Or, alternatively, the combination of these correction amounts may be performed by means of a mathematical formula. Needless to say, the method of the combination of these correction amounts is not limited to those explained above. If the number of correction amount that is determined by the correction-amount determining section is one, the combining section may skip the combination explained above. That is, if the correction-amount determining section determines a single correction amount for a single adjacent pixel only, this single correction amount is used as the “combined” correction amount mentioned above without any summation. The scope of this aspect of the invention (e.g., recitation of appended claim 1) encompasses such a configuration, albeit the constituent element “combining section” is included therein.

After the combination of correction amounts into one combined correction amount, the correcting section corrects the first-mentioned one signal portion on the basis of the combined correction amount. The correcting section is provided with, for example, a processor, a memory, and the like. As a typical non-limiting configuration example thereof, the correcting section corrects the first-mentioned one signal portion by adding the combined correction amount to the first-mentioned one signal portion or by subtracting the combined correction amount from the first-mentioned one signal portion. Through such addition of the combined correction amount to the first-mentioned one signal portion or through such subtraction of the combined correction amount from the first-mentioned one signal portion, though not limited thereto, the voltage level of the first-mentioned one signal portion changes so as to reduce a potential difference between the above-mentioned one signal portion and another one or more signal portions corresponding to the above-mentioned one or more pixels that are adjacent to the first-mentioned one pixel.

After the correction processing, a signal supplying section supplies the corrected image signal, which is obtained as a result of the correction of the first-mentioned one signal portion that is a part of the original image signal, to the electro-optical device in a predetermined format. The signal supplying section is provided with a processor, a memory, and a power supply/source, without any limitation thereto. For example, the signal supplying section supplies the corrected image signal to the electro-optical device in a serial pixel signal format on a scanning-line-by-scanning-line basis. Or, the signal supplying section supplies the corrected image signal to the electro-optical device in a serial/parallel converted image signal format (or “phase-expanded” image signal format), which is adopted when a plurality of data lines is driven concurrently therewith. Through a series of processing explained above, a driving device according to the first aspect of the invention described above drives an electro-optical device so as to display an image on the display area thereof. As a typical non-limiting configuration example thereof, a driving device according to the first aspect of the invention described above supplies a scanning signal in synchronization with the supply of such a corrected image signal to an electro-optical device in a predetermined format. However, the scope of this aspect of the invention is not limited to such an exemplary configuration. For example, a scanning line driving circuit that is provided as a discreet circuit separated from a driving device according to the first aspect of the invention described above may supply such a scanning signal to the electro-optical device.

Herein, it is assumed for the purpose of explanation that unique correction according to the first aspect of the invention described above is not performed. Without the unique correction according to the first aspect of the invention described above, a relatively large potential difference occurs between the above-mentioned one signal portion and another one or more signal portions corresponding to the above-mentioned one or more pixels that are adjacent to the first-mentioned one pixel. Such a relatively large potential difference between the above-mentioned one signal portion and another one or more signal portions corresponding to the above-mentioned one or more pixels that are adjacent to the first-mentioned one pixel could cause, for example, a horizontal electric field, though not limited thereto. The horizontal electric field could cause disclination-line display unevenness at a region between adjacent pixels or in a pixel area. Especially, it is likely that the disclination-line display unevenness (i.e., disclination lines) is visually recognized if any unexpected horizontal electric field is generated when it is supposed that a vertical electric field is applied in a direction perpendicular to the surface of a substrate, which is the typical configuration of a vertically driven electro-optical device. When the disclination line(s) occurs, it appears as local (i.e., regional, partial, or the like) darkness in a pixel area due to a decrease in brightness (i.e., luminance). Or, the disclination line might be observed as a bright area due to optical leakage. Consequently, it is visually perceived as display unevenness. This means that image quality deteriorates.

In this respect, as explained above, a driving device according to the first aspect of the invention corrects the first-mentioned one signal portion on the basis of the combined correction amount. By this means, it is possible to reduce a potential difference between the above-mentioned one signal portion and another one or more signal portions corresponding to the above-mentioned one or more pixels that are adjacent to the first-mentioned one pixel. Therefore, it is possible to prevent any disclination line from being generated. Moreover, in the operation of a driving device according to the first aspect of the invention described above, the combining section combines, into one combined correction amount, correction amounts each of which is determined for the corresponding adjacent pixel so as to be used for correction at the first-mentioned one pixel. By this means, it is possible to perform correction while taking all influences exerted from all correction-amount-determined adjacent pixels into consideration. With such a configuration, it is possible to correct an original image signal accurately (e.g., with excellent correction performance, without any limitation thereto) even in a case where there is more than one adjacent pixel next to one pixel. Note that, in such a case, one influence that is exerted from one of these adjacent pixels could be different from another influence that is exerted from another adjacent pixel. Even in such a case, a driving device according to the first aspect of the invention described above is capable of correcting an original image signal while taking all influences exerted from all correction-amount-determined adjacent pixels into consideration. This means that a driving device according to the first aspect of the invention described above is capable of preventing the generation of a disclination line while taking “human eye” characteristics, that is, visual recognition/performance of an observer who monitors an electro-optical device, into consideration. Thus, a driving device according to the first aspect of the invention described above makes it possible to enhance the display quality of an electro-optical device quite effectively.

A display image becomes slightly blurred when the correcting section corrects the first-mentioned one signal portion so as to reduce a potential difference between the above-mentioned one signal portion and another one or more signal portions corresponding to the above-mentioned one or more pixels that are adjacent to the first-mentioned one pixel. That is, an image blur occurs as a by-product of the reduction of a gradation difference therebetween. Despite the fact that such an image blur occurs, the overall display quality of an electro-optical device improves because a driving device according to the first aspect of the invention described above is capable of preventing the generation of any disclination line in the display area of the electro-optical device, which offsets the negative image-blur effects of the correction and thus contributes to the overall enhancement of the image quality thereof. Especially when a driving device according to the first aspect of the invention described above drives such a type of an electro-optical device that features a smaller size of pixels for higher definition, almost no display blur that is attributable to correction will be visually perceived, or even better, no display blur due to correction will be visually perceived at all in a practical sense. In contrast, disclination lines are very conspicuous/noticeable because they appear on a display screen as, for example, dark lines or bright lines. Therefore, even with the negative effects of an image blur, a driving device according to the first aspect of the invention described above is capable of enhancing the overall display quality of an electro-optical device quite effectively because the aforementioned problem of the disclination-line display unevenness does not arise.

As explained above, a driving device according to the first aspect of the invention is capable of correcting an original image signal through the calculation of a gradation difference between one pixel and adjacent pixel(s). Therefore, a driving device according to the first aspect of the invention makes it possible to prevent the generation of any disclination line in the display area of an electro-optical device, thereby making it further possible to enhance the image quality thereof.

In the configuration of a driving device according to the first aspect of the invention described above, it is preferable that the calculating section should calculate, on an adjacent-pixel-by-adjacent-pixel basis, a difference in the gradation of the original image signal in the first-mentioned one pixel and the gradation of the original image signal in, among all of the above-mentioned plurality of pixels that are adjacent to the first-mentioned one pixel, some pixels that are adjacent to the first-mentioned one pixel when viewed in a certain direction.

In the preferred configuration of a driving device according to the first aspect of the invention described above, the calculating section calculates, on an adjacent-pixel-by-adjacent-pixel basis, a difference in the gradation of the original image signal in the first-mentioned one pixel and the gradation of the original image signal in, among all of the above-mentioned plurality of pixels that are adjacent to the first-mentioned one pixel, some pixels that are adjacent to the first-mentioned one pixel when viewed in a certain direction. That is, the calculating section does not calculate, on an adjacent-pixel-by-adjacent-pixel basis, a difference in the gradation of the original image signal in the first-mentioned one pixel and the gradation of the original image signal in, among all of the above-mentioned plurality of pixels that are adjacent to the first-mentioned one pixel, any of the remaining pixels that are not adjacent to the first-mentioned one pixel when viewed in the above-mentioned certain direction but adjacent to the first-mentioned one pixel when viewed in any direction other than the above-mentioned certain direction.

In some cases, among all of the above-mentioned another one or more signal portions corresponding to the above-mentioned one or more pixels that are adjacent to the first-mentioned one pixel, it is only some of them that actually affect the first-mentioned one signal portion, which corresponds to the first-mentioned one pixel. For example, in some cases, the direction of the generation of a disclination line(s) in the display area of an electro-optical device such as a liquid crystal device that is driven by means of a driving device according to the first aspect of the invention described above is limited. That is, in some cases, a disclination line appears in not all but some direction(s) only. The limited direction of the possible generation of a disclination line is predetermined on the basis of, for example, a rubbing direction and/or the tilt of liquid crystal molecules. For this reason, it is possible to perform effective correction even without calculating a difference for each of all adjacent pixels.

In the preferred configuration of a driving device according to the first aspect of the invention described above, as explained above, the calculating section calculates, on an adjacent-pixel-by-adjacent-pixel basis, a difference in the gradation of the original image signal in the first-mentioned one pixel and the gradation of the original image signal in, among all of the above-mentioned plurality of pixels that are adjacent to the first-mentioned one pixel, some pixels that are adjacent to the first-mentioned one pixel when viewed in a certain direction. By this means, it is possible to simplify the operation of a driving device, including but not limited to the determination of a correction amount on an adjacent-pixel-by-adjacent-pixel basis and the combination of correction amounts into one combined correction amount. By this means, it is possible to effectively prevent the generation of any disclination line while reducing the processing burden of a device.

In the configuration of a driving device according to the first aspect of the invention described above, it is preferable that the correction-amount determining section should determine the correction amount by multiplying the difference that is calculated on an adjacent-pixel-by-adjacent-pixel basis by a predetermined correction coefficient.

In the preferred configuration of a driving device according to the first aspect of the invention described above, the correction-amount determining section determines the correction amount by multiplying the difference that is calculated on an adjacent-pixel-by-adjacent-pixel basis by a predetermined correction coefficient. For example, a simulation is performed in order to find an optimum correction coefficient while using a plurality of correction coefficient candidates. The predetermined correction coefficient mentioned above is set in advance on the basis of the result of such a simulation. The number of predetermined correction coefficient mentioned above is not limited to one. That is, a plurality of predetermined correction coefficients may be prepared so as to allow selection among them depending on, for example, the value of a difference.

With the use of such a predetermined correction coefficient, it is possible to determine a correction amount in an easy manner. Therefore, a driving device that has the preferred configuration described above makes it possible to prevent the generation of any disclination line in the display area of an electro-optical device with increased reliability, thereby making it further possible to enhance the image quality thereof.

In the preferred configuration of a driving device according to the first aspect of the invention described above in which the correction-amount determining section determines the correction amount by multiplying the difference that is calculated on an adjacent-pixel-by-adjacent-pixel basis by a predetermined correction coefficient, it is further preferable that one predetermined correction coefficient should be set so as to be used in a case where the adjacent pixel is provided next to the first-mentioned one pixel when viewed in one direction, and another predetermined correction coefficient should be set so as to be used in a case where the adjacent pixel is provided next to the first-mentioned one pixel when viewed in another direction that intersects with the above-mentioned one direction.

If such a preferred configuration is adopted, when the correction-amount determining section determines the correction amount by multiplying the difference that is calculated on an adjacent-pixel-by-adjacent-pixel basis by a predetermined correction coefficient, one predetermined correction coefficient is used in a case where the adjacent pixel is provided next to the first-mentioned one pixel when viewed in one direction, whereas another predetermined correction coefficient is used in a case where the adjacent pixel is provided next to the first-mentioned one pixel when viewed in another direction that intersects with the above-mentioned one direction. That is, a plurality of predetermined correction coefficients that are different from each other (or one another) is selectively used depending on the array direction in which the adjacent pixel(s) and the first-mentioned one pixel are provided next to each other. For example, it is assumed here again for the purpose of explanation that four adjacent pixels surround one center pixel so as to form a cross. One of these four adjacent pixels is located to the left of the above-mentioned one center pixel, whereas another one of these four adjacent pixels is located to the right of the above-mentioned one center pixel. Still another one of these four adjacent pixels is located on the preceding row at the corresponding position when viewed from the above-mentioned one center pixel, whereas the remaining one of these four adjacent pixels is located on the next row at the corresponding position when viewed from the above-mentioned one center pixel. In such a cross array, as a typical non-limiting configuration example of a driving device that has the preferred configuration described above, the correction-amount determining section determines the correction amount while selectively using two predetermined correction coefficients that are different from each other depending on the array direction. One predetermined correction coefficient thereof is used for two adjacent pixels each of which is provided next to the first-mentioned one pixel when viewed in a horizontal direction, whereas the other predetermined correction coefficient thereof is used for the remaining two adjacent pixels each of which is provided next to the first-mentioned one pixel when viewed in a vertical direction.

With such selective use of a plurality of predetermined correction coefficients depending on a pixel array direction, the correction-amount determining section can determine an appropriate correction amount even in such a case where display characteristics differ depending on the pixel array direction. For example, in a case where a driver operates an electro-optical device while reversing the polarities of an image signal on a scanning-line-by-scanning-line basis, that is, in a so-called 1H reverse drive scheme, a disclination line is more likely to be generated between two pixels arrayed adjacent to each other when viewed in a direction intersecting with each scanning line. In such a case, one predetermined correction coefficient that is to be used for correction for the above-mentioned two pixels arrayed adjacent to each other when viewed in the direction intersecting with each scanning line is set at a large value. By this means, it is possible to determine an appropriate correction amount.

Since the correction-amount determining section can determine an appropriate correction amount, it is possible to effectively prevent the generation of any disclination line at the time of image display. Therefore, a driving device that has the preferred configuration described above makes it possible to enhance the display quality of an electro-optical device.

It is preferable that The device according to the first aspect of the invention described above should further include a memorizing section that stores at least either one of the one signal portion and the plurality of signal portions, wherein the calculating section calculates the difference by means of the signal portion stored in the memorizing section.

In such a preferred configuration, a memorizing section stores at least either one of “the one” signal portion and the plurality of signal portions so that it can be used for the calculation of a difference. The memorizing section is provided with, for example, a line buffer memory, a frame buffer memory, or the like. The calculating section calculates the difference by means of the signal portion stored in the memorizing section, that is, at least either one of the one signal portion and the plurality of signal portions stored therein. More specifically, for example, in a case where the plurality of signal portions is stored in the memorizing section, the calculating section calculates a difference between the plurality of signal portions stored in the memorizing section and one inputted signal portion. In a case where both of the one signal portion and the plurality of signal portions are stored in the memorizing section, the calculating section calculates a difference by means of both of the one signal portion and the plurality of signal portions.

For example, in the operation of a Y-correction driving device, which calculates a difference for pixels that are arrayed adjacent to each other in the direction intersecting with each scanning line, the timing of the supply of a signal portion to one pixel and the timing of the supply of a signal portion to the other pixel that are provided next to the above-mentioned one pixel differ from each other with a timing difference that is larger than that of X-directional correction in which a difference is calculated for pixels that are arrayed adjacent to each other in the direction in which each scanning line extends. For this reason, in a case where a difference is calculated for pixels that are arrayed adjacent to each other in the direction intersecting with each scanning line, it is difficult to successfully calculate a difference by means of the direct input of two signal portions. That is, in such a case, it is difficult to successfully calculate a difference without storing either one of these two signal portions.

In this respect, if the preferred configuration of a driving device described above is adopted, the memorizing section stores at least either one of the one signal portion and the plurality of signal portions. With such a configuration, even in a case where the timing of the supply of a signal portion to one pixel and the timing of the supply of a signal portion to the other pixel that are provided next to the above-mentioned one pixel differ significantly from each other, it is possible to calculate a difference easily. Therefore, the correction-amount determining section can determine a correction amount without fail. Therefore, a driving device that has the preferred configuration described above makes it possible to prevent the generation of any disclination line in the display area of an electro-optical device with further increased reliability, thereby making it further possible to enhance the image quality thereof.

In order to address the above-identified problem without any limitation thereto, the invention provides, as a second aspect thereof, a method for driving an electro-optical device, the driving method correcting an original image signal that indicates, on a pixel-by-pixel basis, an image that is to be displayed in a pixel area, which is made up of a plurality of arrayed pixels, the driving method supplying a corrected image signal to the electro-optical device that has the pixel area so as to drive the electro-optical device, the driving method including: (1) calculating, on an adjacent-pixel-by-adjacent-pixel basis, a difference in a gradation of the original image signal in one of the plurality of arrayed pixels and a gradation of the original image signal in another one or more pixels that are adjacent to the first-mentioned one pixel; (2) determining, on an adjacent-pixel-by-adjacent-pixel basis, and on the basis of the calculated difference, a correction amount that is used for correcting one signal portion that is a part of the original image signal and corresponds to the first-mentioned one pixel, in such a manner that a potential difference between the above-mentioned one signal portion and another one or more signal portions corresponding to the above-mentioned one or more pixels that are adjacent to the first-mentioned one pixel is reduced; (3) combining, into one combined correction amount, correction amounts each of which is determined for the corresponding adjacent pixel so as to be used for correction at the first-mentioned one pixel; (4) correcting the first-mentioned one signal portion on the basis of the combined correction amount; and (5) supplying the corrected image signal, which is obtained as a result of the correction of the first-mentioned one signal portion that is a part of the original image signal, to the electro-optical device in a predetermined format.

If a driving method according to the second aspect of the invention is adopted, it is possible to correct an original image signal through the calculation of a gradation difference between one pixel and adjacent pixel(s). That is, a driving method according to the second aspect of the invention offers the same non-limiting advantageous effects as those offered by a driving device according to the first aspect of the invention described above. Therefore, a driving method according to the second aspect of the invention makes it possible to prevent the generation of any disclination line in the display area of an electro-optical device, thereby making it further possible to enhance the image quality thereof.

Any of the preferred modes of the invention described above, which add restrictive features to the fundamental features of the driving device according to the first aspect of the invention, may be applied to the driving method according to the second aspect of the invention. If so applied, the driving method according to the second aspect of the invention that features any of the preferred modes of the invention offers the same operation/working effects as those of the preferred driving device according to the first aspect of the invention explained above.

In order to address the above-identified problem without any limitation thereto, the invention provides, as a third aspect thereof, an electro-optical device that is provided with a driving device according to the first aspect of the invention, which has any of the configurations described above, including its preferred or modified configurations.

Since an electro-optical device according to the third aspect of the invention is provided with a driving device according to the first aspect of the invention described above, it is possible to prevent the generation of any disclination line in the display area thereof, thereby making it further possible to enhance the image quality thereof.

In order to address the above-identified problem without any limitation thereto, the invention provides, as a fourth aspect thereof, an electronic apparatus that is provided with an electro-optical device according to the third aspect of the invention, which has any of the configurations described above, including its preferred or modified configurations.

According to an electronic apparatus of this aspect of the invention, it is possible to embody various kinds of electronic devices that are capable of providing a high-quality image display, including but not limited to, a projection-type display device, a television, a mobile phone, an electronic personal organizer, a word processor, a viewfinder-type video tape recorder, a direct-monitor-view-type video tape recorder, a workstation, a videophone, a POS terminal, a touch-panel device, and so forth, because the electronic apparatus of this aspect of the invention is provided with the electro-optical device according to the above-described aspect of the invention. In addition, as another non-limiting application example thereof, an electronic apparatus of this aspect of the invention may be also embodied as an electrophoresis apparatus such as a sheet of electronic paper.

These and other features, operations, and advantages of the present invention will be fully understood by referring to the following detailed description of exemplary embodiments in conjunction with the accompanying drawings.

### BRIEF DESCRIPTION OF THE DRAWINGS

The invention will be described with reference to the accompanying drawings, wherein like numbers reference like elements.

FIG. 1 is a plan view that schematically illustrates an example of the general configuration of a liquid crystal device according to an exemplary embodiment of the invention.

FIG. 2 is a sectional view taken along the line II-II of FIG. 1.

FIG. 3 is an equivalent circuit diagram that schematically illustrates an example of constituent elements and wirings in a plurality of pixels that are arranged in a matrix pattern so as to constitute the image display region of a liquid crystal device according to an exemplary embodiment of the invention.

FIG. 4 is a perspective view that schematically illustrates an example of the general appearance of a driving device according to an exemplary embodiment of the invention and an electro-optical device driven by the driving device; more specifically, FIG. 4 shows an example of the connection configuration thereof.

FIG. 5 is a block diagram that schematically illustrates an example of the configuration of a driving device that performs X-directional correction according to an exemplary embodiment of the invention.

FIG. 6 is a flowchart that schematically illustrates an example of the X-directional correction of a driving device according to an exemplary embodiment of the invention.

FIG. 7 is a table that shows a signal that is outputted to the functional component units of a driving device according to an exemplary embodiment of the invention.

FIG. 8 is a block diagram that schematically illustrates an example of the configuration of a driving device that performs Y-directional correction according to an exemplary embodiment of the invention.

FIG. 9 is a flowchart that schematically illustrates an example of the Y-directional correction of a driving device according to an exemplary embodiment of the invention.

FIG. 10 is a plan view that schematically illustrates an example of the positional relationship between a correction target pixel and adjacent pixels according to an exemplary embodiment of the invention.

FIG. 11A is a plan view that schematically illustrates a modification example of the positional relationship between a correction target pixel and adjacent pixels according to an exemplary embodiment of the invention (Modification Example 1).

FIG. 11B is a plan view that schematically illustrates a modification example of the positional relationship between a correction target pixel and an adjacent pixel according to an exemplary embodiment of the invention (Modification Example 2).

FIG. 11C is a plan view that schematically illustrates a modification example of the positional relationship between a correction target pixel and an adjacent pixel according to an exemplary embodiment of the invention (Modification Example 3).

FIG. 12 is a plan view that schematically illustrates an example of the configuration of a projector, which is an example of electronic apparatuses to which an electro-optical device according to an aspect of the invention is applied.

### DESCRIPTION OF EXEMPLARY EMBODIMENTS

With reference to the accompanying drawings, exemplary embodiments of the present invention are described below.

### Electro-Optical Device

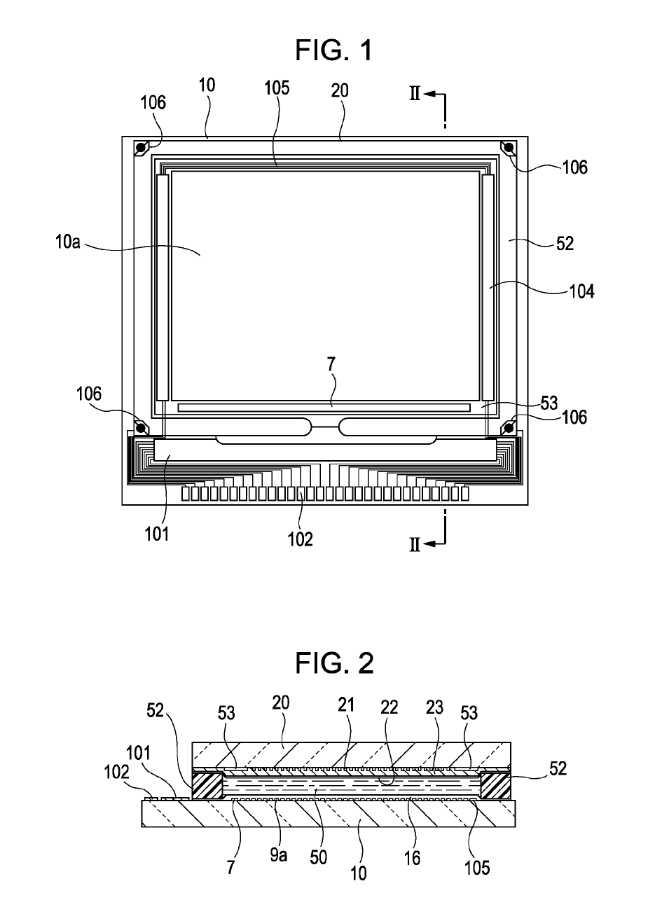

First of all, an example of the configuration of an electro-optical device that is driven by a driving device (i.e., driver) according to an exemplary embodiment of the invention is explained while referring to FIGS. 1, 2, and 3. In the following description of an exemplary embodiment of the invention, a liquid crystal device that conforms to a thin-film-transistor (hereafter abbreviated as TFT) active-matrix driving scheme is taken as an example of various kinds of electro-optical devices to which a driving device according to an aspect of the invention can be applied. It is assumed that the liquid crystal device explained below is provided with a built-in driving circuit.

With reference to FIGS. 1 and 2, an explanation is given of an example of the general configuration of an electro-optical device (e.g., liquid crystal device) according to the present embodiment of the invention. FIG. 1 is a plan view that schematically illustrates an example of the configuration of a liquid crystal device according to the present embodiment of the invention. FIG. 2 is a sectional view taken along the line II-II of FIG. 1.

As shown in FIGS. 1 and 2, in the configuration of a liquid crystal device according to the present embodiment of the invention, a TFT array substrate 10 and a counter substrate 20 are provided opposite to each other. The TFT array substrate 10 is configured as a transparent substrate that is made of, for example, a quartz substrate, a glass substrate, a silicon substrate, or the like. The counter substrate (i.e., opposite substrate) 20 is also formed as a transparent substrate. A liquid crystal layer 50 is sealed between the TFT array substrate 10 and the counter substrate 20. The TFT array substrate 10 and the counter substrate 20 are bonded to each other with the use of a sealant material 52 that is provided at a sealing region (i.e., sealing area) around an image display region (i.e., image display area) 10a where a plurality of pixel electrodes are provided.

The sealant material 52 is made from, for example, an ultraviolet (UV) curable resin, a thermosetting resin, or the like, which functions to paste these substrates together. In the production process of the liquid crystal device according to the present embodiment of the invention, the sealant material 52 is applied onto the TFT array substrate 10 and subsequently hardened through ultraviolet irradiation treatment, heat treatment, or any other appropriate treatment. A gap material such as glass fibers, glass beads, or the like, are scattered in the sealant material 52 so as to set the distance (i.e., inter-substrate gap) between the TFT array substrate 10 and the counter substrate 20 at a predetermined gap value.

Inside the sealing area at which the sealant material 52 is provided, and in parallel therewith, a picture frame light-shielding film 53, which has light-shielding property and defines the picture frame region of the image display area 10a, is provided on the counter substrate 20. Notwithstanding the above, however, a part or a whole of the picture frame light-shielding film 53 may be provided at the TFT-array-substrate (10) side as a built-in light-shielding film.

A data line driving circuit 101 and external circuit connection terminals 102 are provided at a certain peripheral region outside the sealing region at which the sealant material 52 is provided in such a manner that these data line driving circuit 101 and external circuit connection terminals 102 are provided along one of four sides of the TFT array substrate 10. A pair of scanning line driving circuits 104 is provided along two of four sides thereof that are not in parallel with the above-mentioned one side in such a manner that each of the scanning line driving circuits 104 is covered by the picture frame light-shielding film 53. In addition to the above, a plurality of electric wirings 105 is provided along the remaining one side of the TFT array substrate 10 that is parallel with the first-mentioned one side thereof. The plurality of electric wirings 105 connects one of the pair of the scanning line driving circuits 104 to the other thereof. The picture frame light-shielding film 53 covers these electric wirings 105. The pair of the scanning line driving circuits 104 is provided outside the image display region 10a in such a manner that each of these scanning line driving circuits 104 extends along the corresponding one of the second-mentioned two sides thereof.

Inter-substrate conductive terminals 106, which connect the TFT array substrate 10 with the counter substrate 20 by means of inter-substrate conductive material 107, are provided on the TFT array substrate 10 at positions corresponding to four corners of the counter substrate 20, respectively. With such a structure, it is possible to establish electric conduction between the TFT array substrate 10 and the counter substrate 20.

As illustrated in FIG. 2, a layered structure (i.e., lamination structure) that includes laminations of TFTs for pixel switching, which are driving/driver elements, and of wirings/lines such as scanning lines, data lines, and the like is formed on the TFT array substrate 10. Pixel electrodes 9a are formed at a layer above the lamination structure described above. An orientation film (i.e., alignment film) is deposited on the pixel electrodes 9a. Each of the pixel electrodes 9a is configured as a transparent electrode, which is made of a transparent (electro-) conductive material such as indium tin oxide (ITO) or the like. The alignment film (i.e., orientation film) is made of an organic film such as a polyimide film or the like. On the other hand, a light-shielding film 23 that has either a grid pattern or a striped pattern is formed on the inner surface of the counter substrate 20. A counter electrode 21 is formed over the entire inner surface of the light-shielded counter substrate 20. An orientation film is formed as the uppermost layer of a lamination structure formed on the counter substrate 20. The counter electrode 21 is made of a transparent electro-conductive material such as indium tin oxide (ITO) or the like. The alignment film is made of an organic film such as a polyimide film or the like. The TFT array substrate 10 and the counter substrate 20 are adhered to each other so that the pixel electrodes 9a formed on the TFT array substrate 10 and the counter electrode 21 formed on the counter substrate 20 face (i.e., are provided opposite to) each other. In addition to these layer constituent elements described above, an electro-optical device according to the present embodiment of the invention further has the liquid crystal layer 50. The liquid crystal layer 50 is formed between the TFT array substrate 10 and the counter substrate 20. The liquid crystal layer 50 is made of liquid crystal that consists of, for example, a mixture of one or more types of nematic liquid crystal element. Such liquid crystal takes a predetermined orientation state between a pair of the above orientation films (i.e., alignment films).

It should be noted that other functional circuits may be provided on the TFT array substrate 10 illustrated in FIGS. 1 and 2 in addition to driving circuits such as the above-described data line driving circuit 101, the scanning line driving circuit 104, and the like, including but not limited to, a sampling circuit that performs the sampling of an image signal that flows on an image signal line so as to supply the sampled signal to a data line, a pre-charge circuit that supplies a pre-charge signal having a predetermined voltage level to each of the plurality of data lines prior to the supplying of an image signal, a test circuit for conducting an inspection on the quality, defects, etc., of the electro-optical device during the production process or before shipment, and the like.

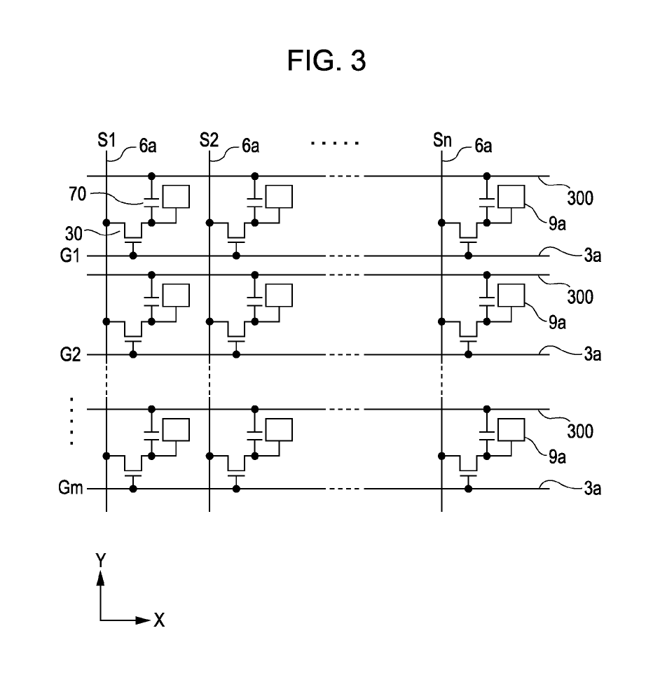

Next, the electric configuration of the pixel unit (i.e., pixel portion) of an electro-optical device according to the present embodiment of the invention is explained below with reference to FIG. 3. FIG. 3 is an equivalent circuit diagram that schematically illustrates an example of constituent elements and wirings in a plurality of pixels that are arranged in a matrix pattern so as to constitute the image display region of a liquid crystal device according to the present embodiment of the invention.

As illustrated in FIG. 3, the pixel electrode 9a and a TFT 30 are provided in each of the plurality of pixels that are arranged in a matrix pattern to constitute the image display region 10a. The TFT 30 is electrically connected to the pixel electrode 9a so as to perform switching control on the pixel electrode 9a at the time of operation of the liquid crystal device according to the present embodiment of the invention. Each of data lines 6a to which image signals are supplied is electrically connected to the source of the TFT 30. Image signals S1, S2, . . . , and Sn that are written on the data lines 6a may be supplied respectively in the order of appearance herein (i.e., in the order of S1, S2, . . . , and Sn) in a line sequential manner. Alternatively, an image signal may be supplied to each of a plurality of groups of the data lines 6a, where each group consists of a bundle of the data lines 6a arrayed adjacent to each other (one another).

Each of scanning lines 3a is connected to the gate of the TFT 30. The liquid crystal device according to the present embodiment of the invention is configured to apply, at a predetermined timing and in a pulse pattern, scanning signals G1, G2, . . . , and Gm to the scanning lines 3a in this order in a line sequential manner. Each of the pixel electrodes 9a is electrically connected to the drain (region/electrode) of the TFT 30. When the switch of the TFT 30, which functions as a switching element, is closed for a certain time period, the image signal S1, S2, . . . , or Sn that is supplied through the data line 6a is written at a predetermined timing. After being written into liquid crystal, which is an example of electro-optical material, via the pixel electrodes 9a, the image signals S1, S2, . . . , and Sn having a predetermined level are held for a certain time period between the pixel electrode 9a and the counter electrode 21 formed on the opposite substrate.

Since liquid crystal that constitutes the liquid crystal layer 50 (refer to FIG. 2) changes its orientation and/or order of molecular association depending on the level of a voltage being applied, it modulates light to realize gradation display. Under a “normally-white” mode, the optical transmittance, that is, light transmission factor, with respect to an incident light beam decreases in accordance with a voltage applied on a pixel-by-pixel basis (i.e., to each pixel), whereas, under a “normally-black” mode, the optical transmittance with respect to an incident light beam increases in accordance with a voltage applied on a pixel-by-pixel basis. Thus, when viewed as a whole, light having a certain contrast in accordance with an image signal is emitted from the liquid crystal device.

In order to prevent the leakage of the image signals being held, a storage capacitor 70 is added in parallel with a liquid crystal capacitor that is formed between the pixel electrode 9a and the counter electrode 21 (refer to FIG. 2). Each of the storage capacitors 70 is a capacitive element that functions as a hold capacitor or a retention volume for temporally holding the electric potential of the corresponding one of the pixel electrodes 9a in accordance with the supply of an image signal. One electrode of the storage capacitor 70 is connected to the drain of the TFT 30 in parallel connection with the pixel electrode 9a, whereas the other electrode thereof is connected to a capacitor line 300 with a fixed electric potential so as to provide a constant electric potential (i.e., potentiostatic). The storage capacitor 70 improves the electric potential retention property at the pixel electrode 9a. Therefore, it is possible to improve display characteristics, which could be perceived as enhanced contrast and/or reduced flickers.

As explained above, in the configuration of an electro-optical device according to the present embodiment of the invention, the pixel electrodes 9a each of which is provided in the corresponding pixel are arrayed adjacent to each other in a matrix pattern, which is made up of a plurality of rows each of which extends in a direction in which a scanning line extends (i.e., the X direction shown in the drawing) and a plurality of columns each of which extends in a direction intersecting with a scanning line (i.e., the Y direction shown in the drawing).

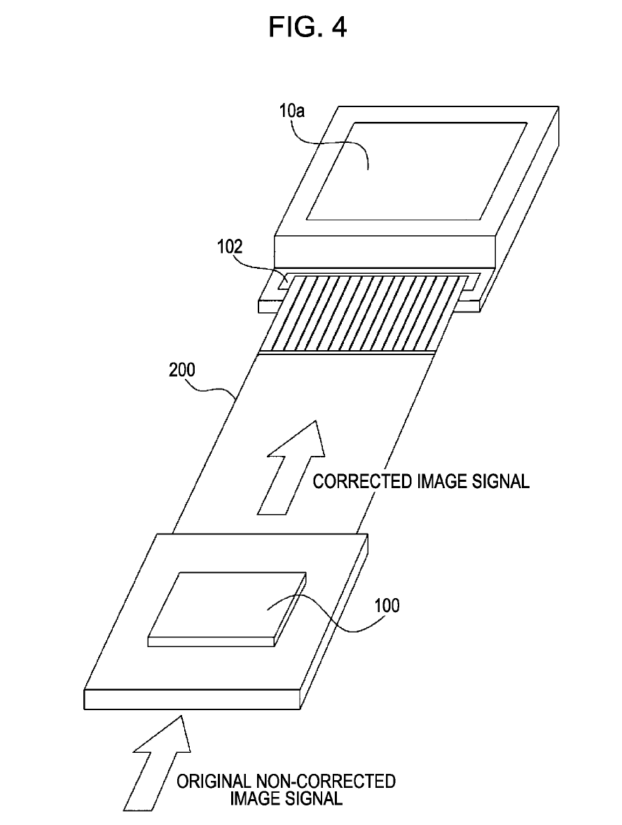

Next, with reference to FIGS. 4-11, the configuration of a driving device according to the present embodiment of the invention as well as the operation thereof, which drives an electro-optical device having the configuration described above, is explained below.

First of all, a general view of a driving device according to the present embodiment of the invention and an electro-optical device described above, which are connected to each other, is explained as a non-limiting example thereof while referring to FIG. 4. FIG. 4 is a perspective view that schematically illustrates an example of the general appearance of a driving device according to the present embodiment of the invention and an electro-optical device driven by the driving device according to the present embodiment of the invention; more specifically, FIG. 3 shows an example of the connection configuration thereof.

A driving device 100 according to the present embodiment of the invention, which is shown in FIG. 4, supplies a corrected image signal to the aforementioned data line driving circuit 101 of an electro-optical device, which is shown in FIGS. 1 and 2, in a predetermined signal format. The corrected image signal is an image signal that has been subjected to correction processing. More specifically, the driving device 100 is electrically connected to the aforementioned external circuit connection terminals 102 of the electro-optical device by means of a flexible connector 200. Because of such a discrete structure, the driving device 100 according to the present embodiment of the invention is provided as an external circuit or an external driver, which is separated from the liquid crystal panel of the electro-optical device (e.g., liquid crystal display device). That is, in the illustrated connection example thereof, the driving device 100 according to the present embodiment of the invention is provided as an image signal supply device or an image signal supply circuit, which supplies corrected image signals to the liquid crystal panel of the electro-optical device from the outside. Or, as a non-limiting example of a variety of modified configurations thereof, the driving device 100 according to the present embodiment of the invention may be provided as an image signal correction device or an image signal correction circuit, which is formed as a built-in circuit component of an original image signal supply device (or circuit), which supplies an original image signal, which has not been subjected to correction processing yet, to the built-in correction device (or circuit) 100. The above-explained modified configuration may be further modified in such a manner that the driving device 100 according to the present embodiment of the invention that is configured as an image signal correction device or an image signal correction circuit is provided at a downstream position of a signal processing flow when viewed from the original image signal supply device (or circuit). If so modified, an original image signal that is outputted from the original image signal supply device (or circuit) is corrected at the downstream correction device (or circuit) 100. Note that the driving device 100 according to the present embodiment of the invention may perform various kinds of processing known in the art such as gamma correction and serial/parallel conversion, though not limited thereto, in addition to the unique correction of an aspect of the invention. A more detailed explanation of the unique correction according to an exemplary embodiment of the invention will be given later.

Next, the configuration and operation of a driving device according to the present embodiment of the invention is explained in detail. The configuration and operation of a driving device according to the present embodiment of the invention differ depending on the array direction of two pixel electrodes 9a to which signal portions are supplied for the purpose of calculating a difference. For this reason, in the following description of this specification, the configuration and operation of a driving device according to the present embodiment of the invention is explained while differentiating a case where these two pixel electrodes 9a are arrayed adjacent to each other in one direction and another case where these two pixel electrodes 9a are arrayed adjacent to each other in another direction. In the following description, it is assumed that one of two signal portions supplied for the purpose of calculating a difference, which has a lower gradation than the other, is subjected to correction. That is, it is preset that one signal portion that is darker than the other is corrected.

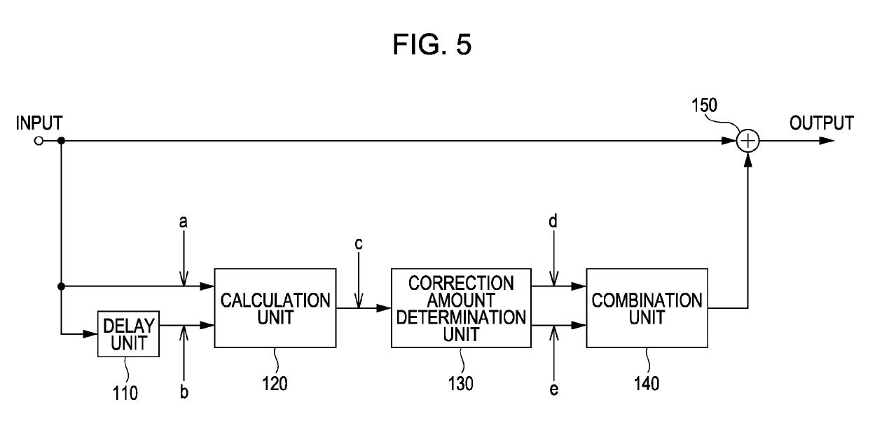

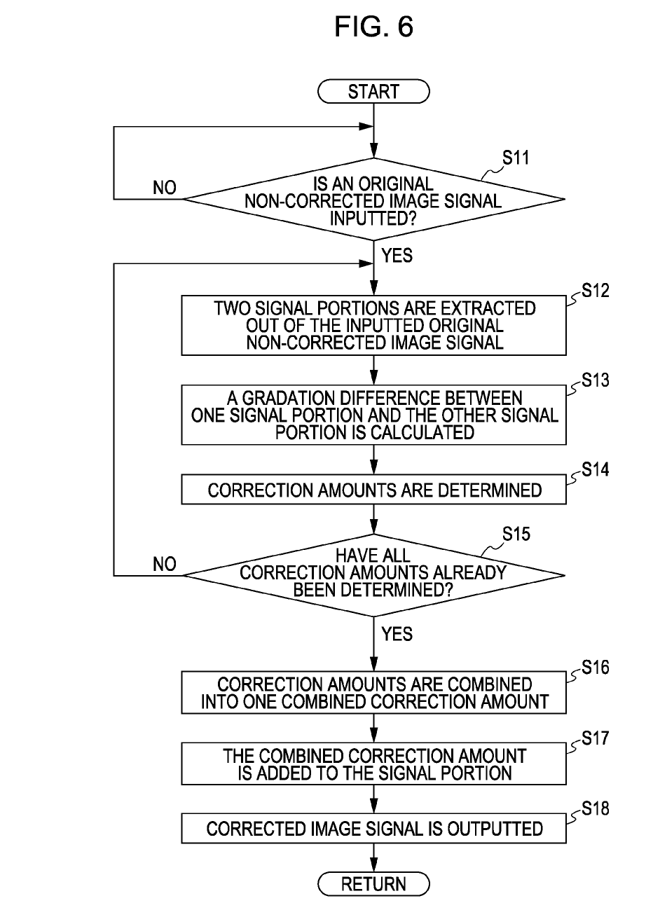

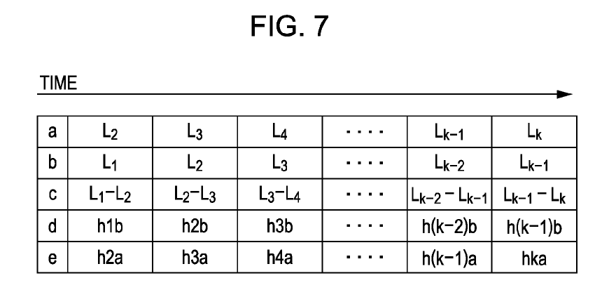

First of all, an explanation is given for a case where two pixel electrodes 9a to which signal portions are supplied for the purpose of calculating a difference are arrayed adjacent to each other in the X direction shown in FIG. 3, which is a direction in which a scanning line extends, with reference to FIGS. 5, 6, and 7. FIG. 5 is a block diagram that schematically illustrates an example of the configuration of a driving device that performs X-directional correction according to an exemplary embodiment of the invention. FIG. 6 is a flowchart that schematically illustrates an example of the X-directional correction of a driving device according to an exemplary embodiment of the invention. FIG. 7 is a table that shows a signal that is outputted to the functional component units of a driving device according to an exemplary embodiment of the invention.

As shown in FIG. 5, a driving device according to the present embodiment of the invention is provided with a delay unit 110, a calculation unit 120, a correction amount determination unit 130, a combination unit 140, and an addition unit 150. The delay unit 110 that is described in the present embodiment of the invention is a non-limiting example of a “memorizing section” according to an aspect of the invention. The calculation unit 120 that is described in the present embodiment of the invention is a non-limiting example of a “calculating section” according to an aspect of the invention. The correction amount determination unit 130 that is described in the present embodiment of the invention is a non-limiting example of a “correction-amount determining section” according to an aspect of the invention. The combination unit 140 that is described in the present embodiment of the invention is a non-limiting example of a “combining section” according to an aspect of the invention. The addition unit 150 that is described in the present embodiment of the invention is a non-limiting example of a “correcting section” according to an aspect of the invention.

The delay unit 110 is a memory device such as a line buffer, though not limited thereto. A signal portion is inputted into the delay unit 110. The inputted signal portion is temporarily stored at the delay unit 110. After the temporary storage, the signal portion is outputted from the delay unit 110. In this way, the delay unit 110 delays the timing of the supply of the signal portion to the calculation unit 120. The delay unit 110 can function as a timing-delay memory as long as it can store a signal portion for one pixel. However, the configuration of the delay unit may be modified in such a manner that it stores signal portions for, for example, one line. The number of the delay unit 110 is not limited to one. A plurality of the delay units 110 may be provided.

The calculation unit 120 is provided with, for example, an arithmetic circuit, a memory, or the like. Upon the reception of two signal portions, the calculation unit 120 calculates a gradation difference between one input signal portion and the other input signal portion. Then, the calculation unit 120 outputs the result of calculation to the correction amount determination unit 130 as a piece of difference information.

The correction amount determination unit 130 is provided with, for example, an arithmetic circuit, a memory, or the like. On the basis of the difference information that is inputted from the calculation unit 120, the correction amount determination unit 130 determines correction amount. The correction amount may be determined by means of, for example, a mathematical formula. Or, the correction amount may be determined on the basis of, for example, a reference table that is prepared in advance.

The combination unit 140 is provided with, for example, an arithmetic circuit, a memory, or the like. The combination unit 140 combines a plurality of correction amounts into one correction amount, which is hereafter referred to as a “combined correction amount”. The correction amount that will be subjected to combination at the combination unit 140 is determined “on an adjacent-pixel-by-adjacent-pixel basis”, which is not always for each adjacent pixel. For example, the combination of these correction amounts may be performed as a result of the addition of them to each other or one another. Or, alternatively, the combination of these correction amounts may be performed by means of a mathematical formula. Needless to say, the method of the combination of these correction amounts is not limited to those explained above.

The addition unit 150 is provided with, for example, an arithmetic circuit, a memory, or the like. The addition unit 150 adds the above-mentioned combined correction amount to a signal portion that is inputted into the addition unit 150. As a result of the addition of the combined correction amount thereto, the addition unit 150 corrects the inputted signal portion. Then, the addition unit 150 supplies the corrected signal portion to an electro-optical device that has the configuration explained above.

As a first step of the operation flow of a driving device according to the present embodiment of the invention, an original image signal is inputted into the device (step S11: YES) as shown in FIG. 6. As has already been explained earlier, an original image signal is supplied to the scanning lines 3a (refer to FIG. 3) of an electro-optical device in a line sequential manner. Next, two signal portions that are used for the calculation of a difference are extracted out of the inputted original image signal (step S12). That is, in this step S12, two signal portions that are supplied to two pixel electrodes 9a that are arrayed adjacent to each other in the X direction inside the image display area 10a, which is shown in FIG. 1, are extracted out of the inputted original image signal. The delay unit 110, which is shown in FIG. 5, temporarily stores an inputted signal portion and then outputs the memorized input signal portion with a delay corresponding to one pixel. In this way, the extraction of signal portions explained above is performed.

Each of two extracted signal portions is inputted into the calculation unit 120. The calculation unit 120 calculates a gradation difference between one signal portion and the other signal portion (step S13). Then, the calculated difference is inputted from the calculation unit 120 into the correction amount determination unit 130. The correction amount determination unit 130 determines a set of correction amounts by multiplying the inputted difference by a (set of) predetermined correction coefficient(s) (step S14). Upon the reception of one difference, the correction amount determination unit 130 determines two correction amounts. More specifically, the correction amount determination unit 130 determines the followings two amounts for correction. It is assumed herein for the purpose of explanation that a first pixel and a second pixel are arrayed adjacent to each other. The correction amount determination unit 130 determines a correction amount that is used for correcting (e.g., canceling, without any limitation thereto) the influence of the first pixel that is exerted on the second pixel and further determines another correction amount that is used for correcting the influence of the second pixel that is exerted on the first pixel on the basis of a single gradation difference between the first pixel and the second pixel. For the determination of these two correction amounts, correction coefficients different from each other may be used.

In the following description, the above-explained steps that constitute a part of the entire operation flow of the X-directional correction of a driving device according to an exemplary embodiment of the invention, specifically, the inputting of an original image signal (step S11), the extraction of two signal portions (step S12), the calculation of a difference (step S13), and the determination of correction amounts (step S14), are explained in detail while referring to FIG. 5. A signal that is outputted to the functional component units of a driving device according to the present embodiment of the invention is also explained.

As illustrated in FIG. 7, at each point in time, the gradation Lₙ (where “n” denotes an integer from 1 inclusive to “k” inclusive) of a signal portion that is supplied to the pixel electrode 9a is outputted at point “a”/“b” shown in FIG. 5. The gradations Lₙ are outputted in a sequential manner. In the first sentence of this paragraph, “k” is the aggregate number of the pixel electrodes 9a that are arrayed adjacent to one another in the X direction. In addition, “n” indicates the n-th pixel electrode 9a counted in the X direction, that is, the ordinal position of the pixel electrode 9a along the X direction. As has already been explained above, a gradation that is outputted at the point “b” falls behind a gradation that is outputted at the point “a” by one pixel because the former is delayed by the delay unit 110. For example, as shown in FIG. 7, the gradation L₁ is outputted at the output point “b” at a point in time when the gradation L₂ is outputted at the output point “a”.

A difference that has been calculated by the calculation unit 120 is outputted at a point “c” shown in FIG. 5. For example, when the gradations L₁ and L₂ are inputted into the calculation unit 120, the difference of L₁−L₂ is outputted from the calculation unit 120 at the point “c”.

At each of output points “d” and “e” shown in FIG. 5, a correction amount that is determined by the correction amount determination unit 130 is outputted. As has already been explained earlier, the correction amount determination unit 130 determines a set of two correction amounts “hna” and “hnb” on the basis of one difference. For example, a signal portion that is supplied to the second pixel electrode 9a affects a signal portion that is supplied to the first pixel electrode 9a. The signal portion that is supplied to the second pixel electrode 9a further affects a signal portion that is supplied to the third pixel electrode 9a. The correction amount determination unit 130 determines a correction amount “h2a”, which is used for correcting the influence of the second-pixel signal portion that is exerted on the first-pixel signal portion, and further determines a correction amount “h2b”, which is used for correcting the influence of the second-pixel signal portion that is exerted on the third-pixel signal portion.

If the aforementioned set of predetermined correction coefficients that are used when the correction amount determination unit 130 determines the set of these two correction amounts hna and hnb are denoted as p₁ and p₂, respectively, these correction amounts are calculated in accordance with the following mathematical formulae (1) and (2), respectively.

hna=(Lₙ₋₁−Lₙ)×p₁ (1)

hnb=(Lₙ−Lₙ₊₁)×p₂ (2)

As explained above, the correction amount determination unit 130 determines correction amounts on the basis of each difference in a sequential manner.

Referring back to FIG. 6, upon the sequential determination of correction amounts, a judgment is made as to whether all correction amounts that will be combined into one combined correction amount (for each pixel) in the subsequent combination process have already been determined or not (step S15). That is, in this step S15, it is judged whether correction amounts for both of adjacent pixels that are next to a certain (each) pixel when viewed in the X direction have already been determined or not. For example, two correction amounts h2a and h2b are used so as to obtain a combined correction amount for a signal portion that is supplied to the second pixel electrode 9a. Therefore, in the above example, a judgment is made as to whether both of these two correction amounts h2a and h2b have already been determined or not in the step S15.

If it is judged that all correction amounts that will be combined into one combined correction amount (for each pixel) in the subsequent combination process have already been determined (step S15: YES), the combination unit 140 combines them into one combined correction amount for each pixel (step S16). That is, one combined correction amount is calculated for each pixel. On the other hand, if it is judged that all correction amounts that will be combined into one combined correction amount (for each pixel) in the subsequent combination process have not been determined yet (step S15: NO), a series of the steps S12, S13, and S14 explained above is repeated so as to determine the remaining correction amounts that have not been determined yet.

The combined correction amount for each pixel is outputted to the addition unit 150. Then, the addition unit 150 adds each combined correction amount to the corresponding signal portion (step S17). By this means, just with a single correction at the adder, that is, just through a single addition process, it is possible to perform correction while taking all influences exerted from all X-directionally adjacent pixels into consideration.

The operation explained above is repeated for all pixel electrodes 9a that are arrayed adjacent to one another in the X direction. In this way, X-directional correction is performed. The correction explained above reduces an electric-potential difference between an image signal portion that is supplied to one pixel and another image signal portion that is supplied to another pixel that is adjacent to the above-mentioned one pixel when viewed in the X direction. Therefore, a driving device that performs X-directional correction according to the present embodiment of the invention makes it possible to prevent the generation of any disclination line in the image display area 10a of an electro-optical device, thereby making it further possible to enhance the image quality thereof.

A driving device for X-directional correction according to the present embodiment of the invention, which is explained above while referring to FIGS. 5, 6, and 7, is configured as a device that supplies a corrected image signal to the aforementioned data line driving circuit 101 of an electro-optical device, which is shown in FIGS. 1 and 2, in a predetermined signal format. However, the scope of this aspect of the invention is not limited to such an exemplary configuration. For example, a driving device for X-directional correction according to the present embodiment of the invention may include the data line driving circuit 101 as a component unit thereof. In addition to or in place thereof, a driving device for X-directional correction according to the present embodiment of the invention may include the scanning line driving circuit 104, which is shown in FIGS. 1 and 2, as a component unit thereof. The same advantageous effects as those offered by a driving device for X-directional correction according to the present embodiment of the invention explained above can be obtained, regardless of whether it is modified as explained above or not, as long as it is provided with functional circuit blocks shown in FIG. 5, which correct an original image signal.

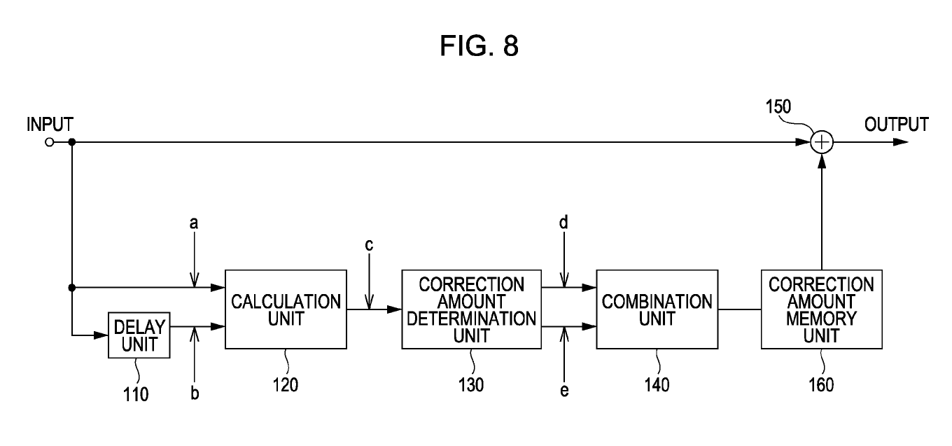

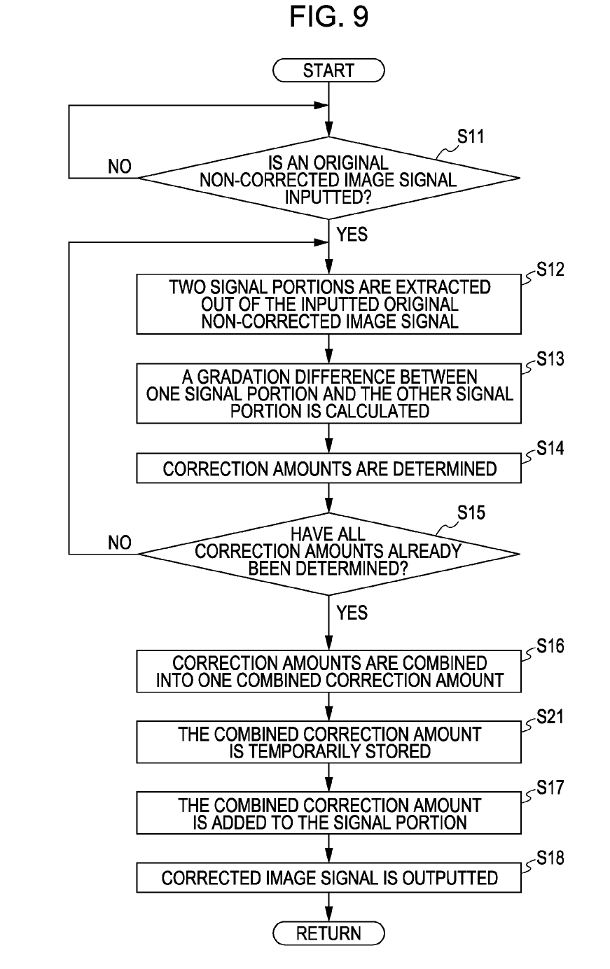

Next, with reference to FIGS. 8 and 9, an explanation is given for a case where two pixel electrodes 9a to which signal portions are supplied for the purpose of calculating a difference are arrayed adjacent to each other in the Y direction shown in FIG. 3, which is a direction intersecting with a scanning line. FIG. 8 is a block diagram that schematically illustrates an example of the configuration of a driving device that performs Y-directional correction according to an exemplary embodiment of the invention. FIG. 9 is a flowchart that schematically illustrates an example of the Y-directional correction of a driving device according to an exemplary embodiment of the invention. In the following description of the configuration of a driving device that performs Y-directional correction according to the present embodiment of the invention and the operation flow of the Y-directional correction of a driving device according to the present embodiment of the invention, the same reference numerals are consistently used for the same components and steps as those of the configuration of a driving device that performs X-directional correction and the operation flow of the X-directional correction of a driving device explained above so as to omit, if appropriate, any redundant explanation or simplify explanation thereof.

As shown in FIG. 8, a Y-correction driving device according to the present embodiment of the invention, which performs Y-directional correction for the pixel electrodes 9a that are arrayed adjacent to one another in the Y direction, is provided with a correction amount memory unit 160 in addition to the above-explained configuration of an X-correction driving device according to the present embodiment of the invention, which performs X-directional correction for the pixel electrodes 9a that are arrayed adjacent to one another in the X direction. The correction amount memory unit 160 is, for example, a memory device that temporarily stores a signal that is inputted therein. The correction amount memory unit 160 stores the combined correction amount defined above, which is outputted from the combination unit 140. In response to an output command issued thereto, the correction amount memory unit 160 outputs the combined correction amount that is temporarily memorized therein.

The operation of the Y-correction driving device according to the present embodiment of the invention, which performs Y-directional correction for the pixel electrodes 9a that are arrayed adjacent to one another in the Y direction, is similar to that of the X-correction driving device according to the present embodiment of the invention, which performs X-directional correction for the pixel electrodes 9a that are arrayed adjacent to one another in the X direction. More specifically, the operation of the Y-correction driving device according to the present embodiment of the invention is the same as that of the X-correction driving device explained above except for step S21, which will be explained later. The operation of the Y-correction driving device according to the present embodiment of the invention is explained in detail below. As a first step of the operation flow thereof, an original image signal is inputted into the device (step S11: YES) as shown in FIG. 9. An original image signal is supplied to the scanning lines 3a (refer to FIG. 3) of an electro-optical device in a line sequential manner. Next, two signal portions that are used for the calculation of a difference are extracted out of the inputted original image signal (step S12). That is, in this step S12, two signal portions that are supplied to two pixel electrodes 9a that are arrayed adjacent to each other in the Y direction inside the image display area 10a, which is shown in FIG. 1, are extracted out of the inputted original image signal.

Unlike the X-directional correction explained above, in the operation of the Y-correction driving device according to the present embodiment of the invention, the delay unit 110 temporarily stores an inputted signal portion and then outputs the memorized input signal portion with a delay corresponding to not one pixel but one line. In this way, the extraction of signal portions explained above is performed. That is, the delay unit 110 temporarily stores signal portions for one line, and then outputs the temporarily stored signal portions in a line-sequential manner at the time when another set of signal portions for the next line is inputted therein. By this means, it is possible to calculate a gradation difference between one signal portion and the other signal portion that differ in terms of input timing from each other. Note that the timing difference of the Y-directional correction described herein is relatively large in comparison with that of the X-directional correction explained above. Specifically, in the Y-directional correction described herein, differences are calculated for gradations Lₘ (where “m” denotes an integer from 1 inclusive to “j” inclusive) of signal portions. In the preceding sentence, “j” is the aggregate number of the pixel electrodes 9a that are arrayed adjacent to one another in the Y direction. In addition, “m” indicates the m-th pixel electrode 9a counted in the Y direction, that is, the ordinal position of the pixel electrode 9a along the Y direction.

A calculated difference is inputted from the calculation unit 120 into the correction amount determination unit 130. The correction amount determination unit 130 determines a set of correction amounts on the basis of the inputted difference (step S14). Upon the reception of one difference, the correction amount determination unit 130 determines two correction amounts “hmc” and “hmd”. For example, a signal portion that is supplied to a pixel electrode 9a of the second line affects a signal portion that is supplied to the corresponding pixel electrode 9a of the first line. The signal portion that is supplied to the pixel electrode 9a of the second line further affects a signal portion that is supplied to the corresponding pixel electrode 9a of the third line. The correction amount determination unit 130 determines a correction amount h2c, which is used for correcting the influence of the second-line signal portion that is exerted on the first-line signal portion, and further determines a correction amount h2d, which is used for correcting the influence of the second-line signal portion that is exerted on the third-line signal portion.

If a set of predetermined correction coefficients that are used when the correction amount determination unit 130 determines the set of these two correction amounts hmc and hmd are denoted as p₃ and p₄, respectively, these correction amounts are calculated in accordance with the following mathematical formulae (3) and (4), respectively.

hmc=(Lₘ₋₁−Lₘ)×p₃ (3)

hmd=(Lₘ−Lₘ₊₁)×p₄ (4)

Upon the determination of correction amounts, the steps S15 and S16 are executed so as to generate the combined correction amount mentioned above. The correction amount memory unit 160 temporarily stores the combined correction amount (step S21). As has already been explained above, in the operation of the Y-correction driving device according to the present embodiment of the invention, which performs Y-directional correction for the pixel electrodes 9a that are arrayed adjacent to each other in the Y direction, the timing of the supply of a signal portion to one pixel electrode 9a and the timing of the supply of a signal portion to the other pixel electrode 9a that are provided next to the above-mentioned one pixel electrode 9a differ from each other with a timing difference that is larger than that of the X-directional correction explained above. For this reason, in the Y-directional correction described herein, it is necessary to synchronize the timing of the inputting of the combined correction amount into the addition unit 150 with the timing of the inputting of the corresponding signal portion to which the combined correction amount should be added in order to perform correction accurately. Since the Y-correction driving device according to the present embodiment of the invention is provided with the additional block component of the correction amount memory unit 160 as explained above, it is possible to output the combined correction amount to the addition unit 150 at an appropriate point in time (i.e., timing). Therefore, it is possible to correct an original image signal without any timing failure. The correction explained above reduces an electric-potential difference between an image signal portion that is supplied to one pixel and another image signal portion that is supplied to another pixel that is adjacent to the above-mentioned one pixel when viewed in the Y direction. Therefore, a driving device that performs Y-directional correction according to the present embodiment of the invention makes it possible to prevent the generation of any disclination line in the image display area 10a of an electro-optical device, thereby making it further possible to enhance the image quality thereof.

A driving device for Y-directional correction according to the present embodiment of the invention, which is explained above while referring to FIGS. 8 and 9, is configured as a device that supplies a corrected image signal to the aforementioned data line driving circuit 101 of an electro-optical device, which is shown in FIGS. 1 and 2, in a predetermined signal format. However, the scope of this aspect of the invention is not limited to such an exemplary configuration. For example, a driving device for Y-directional correction according to the present embodiment of the invention may include the data line driving circuit 101 as a component unit thereof. In addition to or in place thereof, a driving device for Y-directional correction according to the present embodiment of the invention may include the scanning line driving circuit 104, which is shown in FIGS. 1 and 2, as a component unit thereof. The same advantageous effects as those offered by a driving device for Y-directional correction according to the present embodiment of the invention explained above can be obtained, regardless of whether it is modified as explained above or not, as long as it is provided with functional circuit blocks shown in FIG. 8, which correct an original image signal.

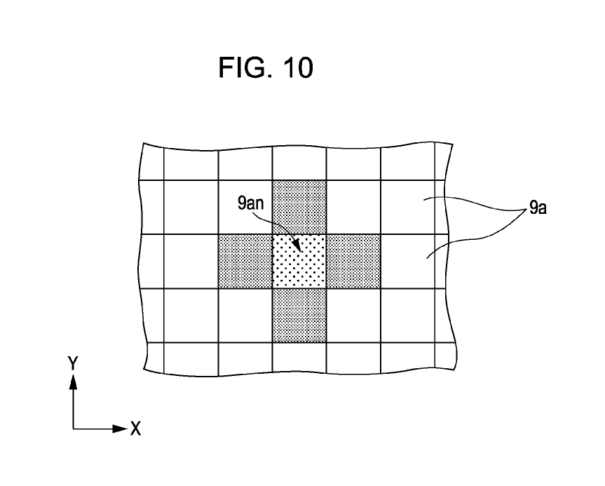

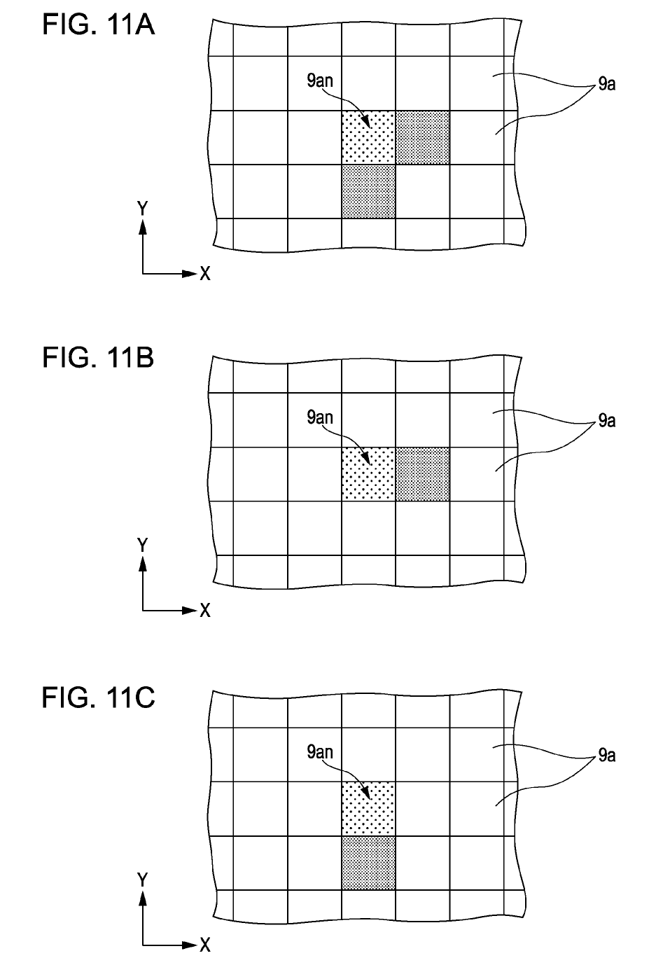

Next, the positional relationship between a correction target pixel and adjacent pixel(s) according to the present embodiment of the invention is explained while referring to FIG. 10 as well as FIGS. 11A, 11B, and 11C. FIG. 10 is a plan view that schematically illustrates an example of the positional relationship between a correction target pixel and adjacent pixels according to an exemplary embodiment of the invention. FIGS. 11A, 11B, and 11C is a set of plan views that schematically illustrates modification examples of the positional relationship between a correction target pixel and adjacent pixel(s) according to an exemplary embodiment of the invention.

Through a combination of the X-directional correction and the Y-directional correction explained above, a signal portion that is supplied to a pixel electrode 9an shown in FIG. 10 is corrected while taking all influences exerted from signal portions that are respectively supplied to four pixels adjacent thereto into consideration. Therefore, a driving device that performs X-directional correction and Y-directional correction according to the present embodiment of the invention makes it possible to prevent the generation of any disclination line in the image display area 10a of an electro-optical device, thereby making it further possible to enhance the image quality thereof. In the foregoing description of an exemplary embodiment of the invention, it is explained that one combined correction amount is generated for X-directional correction and another combined correction amount is generated for Y-directional correction. However, the technical scope of the invention is not limited to such an exemplary configuration/operation. For example, the combination of correction amounts into one combined correction amount for the X-directional correction and the combination of correction amounts into one combined correction amount for the Y-directional correction may be performed at the same time as a single combination process. In other words, in a case where there are pixels adjacent to one pixel in more than one direction, the combination of correction amounts into one combined correction amount for a plurality of directions may be performed at the same time as a single combination process.

Note that it is not necessary to perform correction for all pixels adjacent to one pixel. That is, as a non-limiting modification example of the X-Y correction explained above, correction may be skipped for some pixel(s) adjacent to one pixel. In other words, correction amounts may be determined for not all but some of adjacent pixels when viewed in a certain direction(s) only. For example, even when either X-directional correction only or Y-directional correction only is performed, it is possible to obtain the same advantageous effect as that explained above, that is, the prevention of any disclination line in the image display area 10a of an electro-optical device.

Especially, in some cases, the direction of the generation of a disclination line(s) in the image display area 10a of a liquid crystal device that is driven by means of a driving device according to the foregoing exemplary embodiment of the invention is limited. That is, in some cases, a disclination line appears in not all but some direction(s) only. The limited direction of the possible generation of a disclination line is predetermined on the basis of, for example, a rubbing direction and/or the tilt of liquid crystal molecules. Therefore, if such characteristics of a liquid crystal device that is driven by means of a driving device according to the foregoing exemplary embodiment of the invention are known in advance, it is possible to perform effective correction without any necessity to calculate a difference for each of all adjacent pixels. For example, as illustrated in FIG. 11A, correction may be performed for one correction target pixel electrode 9an while taking influences exerted from not all but two adjacent pixels only into consideration, one of which is located to the right of the correction target pixel electrode 9an, and the other of which is located on the next row at the corresponding position when viewed from the correction target pixel electrode 9an, or simply said, located under the correction target pixel electrode 9an. As another non-limiting modification example thereof, correction may be performed for the correction target pixel electrode 9an while taking an influence exerted from only one adjacent pixel that is located to the right of the correction target pixel electrode 9an into consideration. An example of such modified correction is illustrated in FIG. 11B. Or, as another non-limiting modification example thereof, correction may be performed for the correction target pixel electrode 9an while taking an influence exerted from only one adjacent pixel that is located on the next row at the corresponding position when viewed from the correction target pixel electrode 9an, or simply said, located under the correction target pixel electrode 9an, into consideration. An example of such modified correction is illustrated in FIG. 11C. It should be noted that one correction amount only is determined in a case where correction is performed for the correction target pixel electrode 9a while taking an influence exerted from one adjacent pixel only into consideration. In such a case, the step S16 that is shown in FIGS. 6 and 9, that is, the combination of correction amounts into one combined correction amount is skipped. That is, in such a case, a single correction amount that is determined for the above-mentioned only one adjacent pixel is used as the aforementioned “combined” correction amount. If correction amounts are determined for not all but some of adjacent pixels when viewed in a certain direction(s) only as explained above, which means that correction is skipped for some pixel(s) adjacent to the correction target pixel, it is possible to effectively prevent the generation of any disclination line while reducing the processing burden of a device.

As explained in detail above, a driving device according to the present embodiment of the invention is capable of correcting an original image signal through the calculation of a gradation difference between one pixel and adjacent pixel(s). Therefore, a driving device according to the present embodiment of the invention makes it possible to prevent the generation of any disclination line in the image display area of an electro-optical device, thereby making it further possible to enhance the image quality thereof. Electronic Apparatus

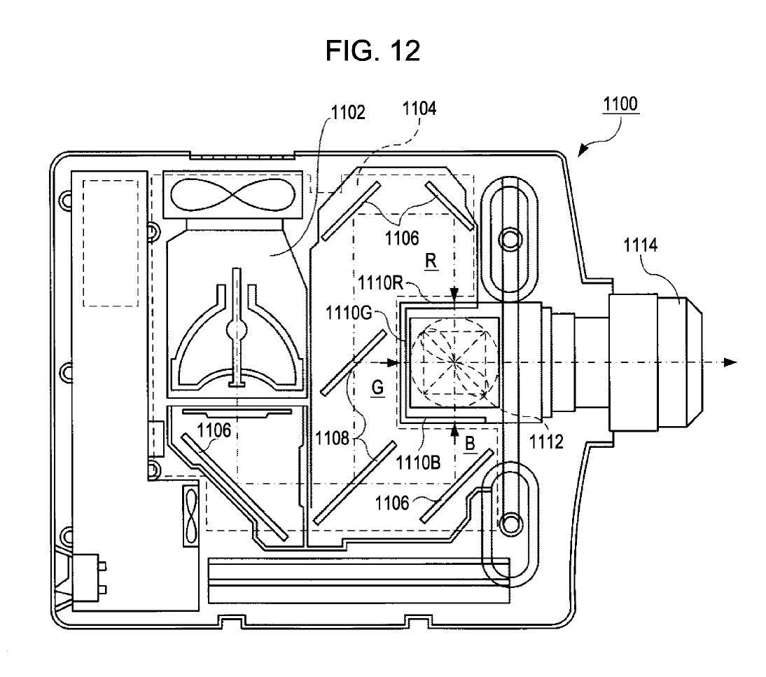

Next, an explanation is given of an example of the applications of a liquid crystal device described above, which is a non-limiting example of an electro-optical device according to an aspect of the invention, to various kinds of electronic apparatuses. FIG. 12 is a plan view that schematically illustrates an example of the configuration of a projector. In the following description, an explanation is given of a projector that employs the above-described liquid crystal device as a light valve.

As illustrated in FIG. 12, a projector 1100 has a plurality of light-emitting diodes 110R, 110G, and 110B as its internal light-source elements. These LEDs 110R, 110G, and 110B correspond to three primary colors of R, G, and B, respectively. Each of the LEDs 110R, 110G, and 110B emits light of the corresponding primary color component in a frequency of, for example, 60 Hz so that light beams are emitted in a sequential manner. Each of red, green, and blue light emitted from the corresponding one of the LEDs 110R, 110G, and 110B enters a color-combination prism 300 as an incident light beam. As a result of combination thereof, a combined light beam is emitted from the color-combination prism 300 toward a liquid crystal panel 200, which is an example of a light valve.

The configuration of the liquid crystal panel 200 is the same as or similar/equivalent to that of a liquid crystal device explained above. An image signal processor (e.g., processing circuit) that is not shown in the drawing supplies a driving signal to the liquid crystal panel 200. A light beam that has been subjected to optical modulation at the liquid crystal panel 200 is outputted through a projection lens 400. In this way, a color image is projected on a projection target medium such as a projection screen or the like.

As explained above, the projector 1100, which is a non-limiting application example of an electro-optical device according to an aspect of the invention, is provided with the light-emitting diodes 110R, 110G and 110B as its internal light-source elements that correspond to three primary colors of R, G, and B, respectively. With such a configuration, it is not necessary to provide any color filter therein. Since it is not necessary to provide any color filter therein, it is possible to achieve cost reduction. In addition thereto, it is possible to achieve high brightness because light does not pass through any color filter.

Among a variety of electronic apparatuses to which the electro-optical device according to an aspect the invention could be embodied are, in addition to the electronic apparatus (projector) explained above with reference to FIG. 12, a mobile-type personal computer, a mobile phone, a liquid crystal display television (i.e., liquid crystal television, LCD television), a viewfinder-type video recorder, a video recorder of a direct monitor view type, a car navigation device, a pager, an electronic personal organizer, an electronic calculator, a word processor, a workstation, a videophone, a POS terminal, a touch-panel device, and so forth. Needless to say, the invention is also applicable to these various electronic apparatuses without any limitation to those enumerated/mentioned above.

The present invention should be in no case interpreted to be limited to the specific embodiments described above. The invention may be modified, altered, changed, adapted, and/or improved within a range not departing from the gist and/or spirit of the invention apprehended by a person skilled in the art from explicit and implicit description given herein as well as recitation of appended claims. A driving device subjected to such modification, alteration, change, adaptation, and/or improvement, a driving method subjected to such modification, alteration, change, adaptation, and/or improvement, an electro-optical device that is driven by and/or is provided with such a driving device and/or is driven by such a driving method, and an electronic apparatus that is provided with such an electro-optical device are also within the technical scope of the invention.

The entire disclosure of Japanese Patent Application No. 2007-277683, filed Oct. 25, 2007 is expressly incorporated by reference herein.

What is claimed is:

1. A device that drives an electro-optical device with a pixel area of arrayed pixels, the driving device comprising:
a calculating section that calculates a difference between a gradation of an original image signal for one of the pixels and a gradation of the original image signal for an adjacent pixel that is adjacent to the one of the pixels;
a correction-amount determining section that determines, on the basis of the difference calculated by the calculating section, a correction amount that is used for correcting a part of the original image signal that corresponds to the one of the pixels, the correction-amount determining section determining the correction amount to reduce a potential difference between the part of the original image signal and another part of the original image signal that corresponds to the adjacent pixel;
a correcting section that corrects the one part of the signal on the basis of the correction amount; and
a signal supplying section that supplies the corrected image signal to the electro-optical device.

2. The device according to claim 1, wherein:
the calculating section calculates an other difference between a gradation of an original image signal for the one of the pixels and a gradation of the original image signal for an other adjacent pixel that is adjacent to the one of the pixels, and
the correction-amount determining section determines, on the basis of the other difference calculated by the calculating section, an other correction amount that is used for correcting the part of the original image signal that corresponds to the one of the pixels, the correction-amount determining section determining the other correction amount to reduce a potential difference between the part of the original image signal and an other part of the original image signal that corresponds to the other adjacent pixel, and further comprising:
a combining section that combines the correction amount and the other correction amount into one combined correction amount, the correcting section correcting the one part of the signal on the basis of the combined correction amount.

3. The device according to claim 2, wherein the calculating section calculates, on an adjacent-pixel-by-adjacent-pixel basis, a difference in the gradation of the original image signal in the first-mentioned one pixel and the gradation of the original image signal in, among all of the above-mentioned plurality of pixels that are adjacent to the first-mentioned one pixel, some pixels that are adjacent to the first-mentioned one pixel when viewed in a certain direction.

4. The device according to claim 2, wherein the correction-amount determining section determines the correction amount by multiplying the difference that is calculated on an adjacent-pixel-by-adjacent-pixel basis by a predetermined correction coefficient.

5. The device according to claim 4, wherein one predetermined correction coefficient is set so as to be used in a case where the adjacent pixel is provided next to the first-mentioned one pixel when viewed in one direction, and another predetermined correction coefficient is set so as to be used in a case where the adjacent pixel is provided next to the first-mentioned one pixel when viewed in another direction that intersects with the above-mentioned one direction.

6. The device according to claim 2, further comprising a memorizing section that stores at least either one of the one signal portion and the plurality of signal portions, wherein the calculating section calculates the difference by means of the signal portion stored in the memorizing section.

7. A method for driving an electro-optical device with a pixel area of arrayed pixels, the driving method comprising:
calculating an other difference between a gradation of an original image signal for the one of the pixels and a gradation of the original image signal for an other adjacent pixel that is adjacent to the one of the pixels;
determining, on the basis of the other difference calculated by the calculating section, an other correction amount that is used for correcting the part of the original image signal that corresponds to the one of the pixels, the correction-amount determining section determining the other correction amount to reduce a potential difference between the part of the original image signal and an other part of the original image signal that corresponds to the other adjacent pixel;
combining the correction amount and the other correction amount into one combined correction amount;
correcting the one part of the signal on the basis of the combined correction amount; and
supplying the corrected image signal to the electro-optical device.

8. An electro-optical device that is provided with the driving device according to claim 1.

9. An electronic apparatus that is provided with the electro-optical device according to claim 8.
